(19) United States
(12) Patent Application Publication
(10) Pub. No.: US 2005/0087979 A1
(43) Pub. Date: Apr. 28, 2005

(54) Hose with hose end having an edge

(75) Inventor: Isa Col, Frankfurt (DE)

Correspondence Address: KODA & ANDROLIA, 2029 CENTURY PARK EAST, SUITE 1430, LOS ANGELES, CA, 90067-3024, US

(73) Assignee: Veritas AG

(21) Appl. No.: 10/966,936

(22) Filed: Oct. 15, 2004

(30) Foreign Application Priority Data
Oct. 22, 2003 (DE) 103 49 527.4

(51) Int. Cl. F16L 55/00

(52) U.S. Cl. 285/23; 285/253; 285/252

(57) ABSTRACT

The invention relates to a hose with a hose end having an edge. Immediately beneath the edge of at least one of its ends, the hose comprises at least one depression on the inside. Into this depression is clipped or pressed one shank of a U-shaped clip, which is part of a clamp fitting securement, which, in turn, encompasses a band clamp fitting. In this way, by means of a clamp fitting securement, fixedly connected with the hose end, a band clamp fitting is also fixedly connected with this hose end.

The invention relates to a hose according to the preamble of patent claim 1.

Hoses, whose ends are fastened on a connecting piece with the aid of a hose clamp fitting are utilized in particular in motor vehicle engines. Such hoses are for example connected with exhaust manifolds of Otto engines. Since these manifolds are often difficult to access, the ends of the hoses are preassembled in the correct position such, that they only need to be slid onto the manifold and connected with it by means of a hose clamp fitting.

A hose is already known, onto whose end a clamp fitting is slid, which with a clamp fastened on the hose extends over the edge of the hose end, (GB 2 343 927 A). The hose end is formed truly cylindrical.

A hose clamp fitting coupled to the edge of a hose end with the aid of clamps is also known (DE 195 33 553 A1). The hose is here also formed truly cylindrical.

Furthermore proposed has been a securement part for a hose clamp fitting comprising clamps, which is guided around the front face of a hose end (DE 103 04 514). The hose end is here not truly cylindrical.

In the case of another proposed securing device for a hose end a clamp is also provided, which clamp, on the one hand, is connected with a hose end and, on the other hand, guided around the margin of a hose end (DE 103 24 236).

The invention addresses the problem of providing a hose end, on which a hose band clamp fitting or the like is securely seated.

This problem is solved with the characteristics of claim 1.

Consequently, the invention relates to a hose with a hose end having an edge. The hose comprises on the inside of at least one of its ends immediately beneath the edge at least one depression. Into this depression is clipped or pressed one shank of a U-shaped clip, which is a part of a clamp fitting securement, which, in turn, encompasses a band clamp fitting. In this way by means of a clamp fitting securement fixedly connected with the hose end, a band clamp fitting is also fixedly connected with this hose end.

The advantage attained with the invention comprises in particular that the end of the hose is partially offset toward the outside. This prevents damaging the connecting piece over which the hose end is slid. In addition, the position of the clamp fitting securement is predetermined.

Embodiment examples of the invention are depicted in the drawings and will be described in further detail in the following. In the drawing show:

FIG. 1 a side view of a first hose end,

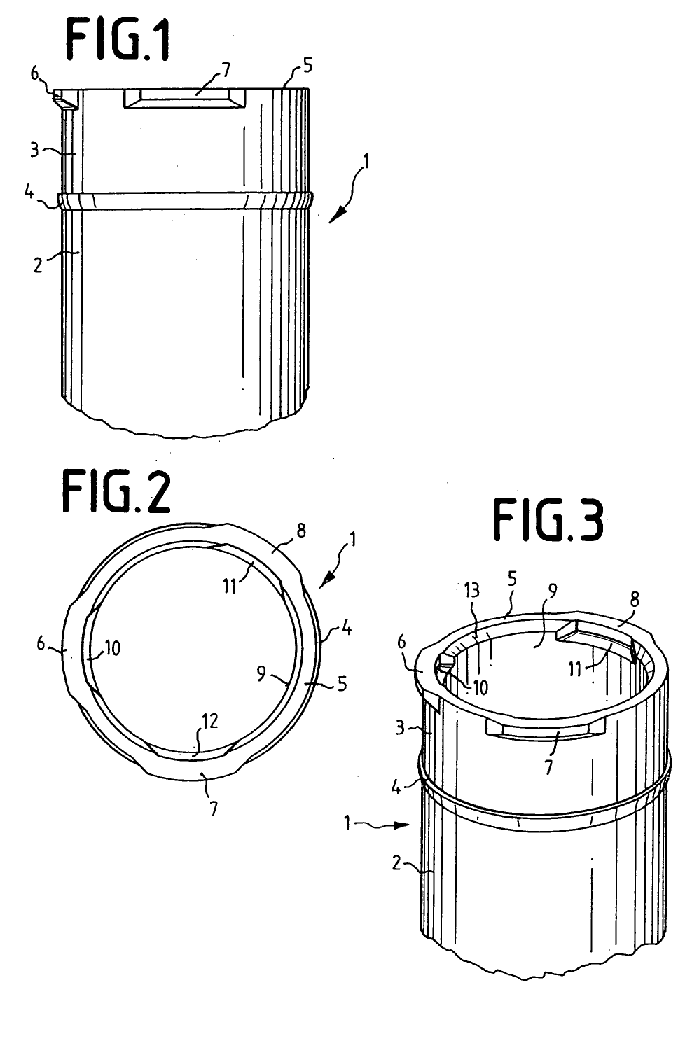

FIG. 2 top view onto the edge region of the first hose end,

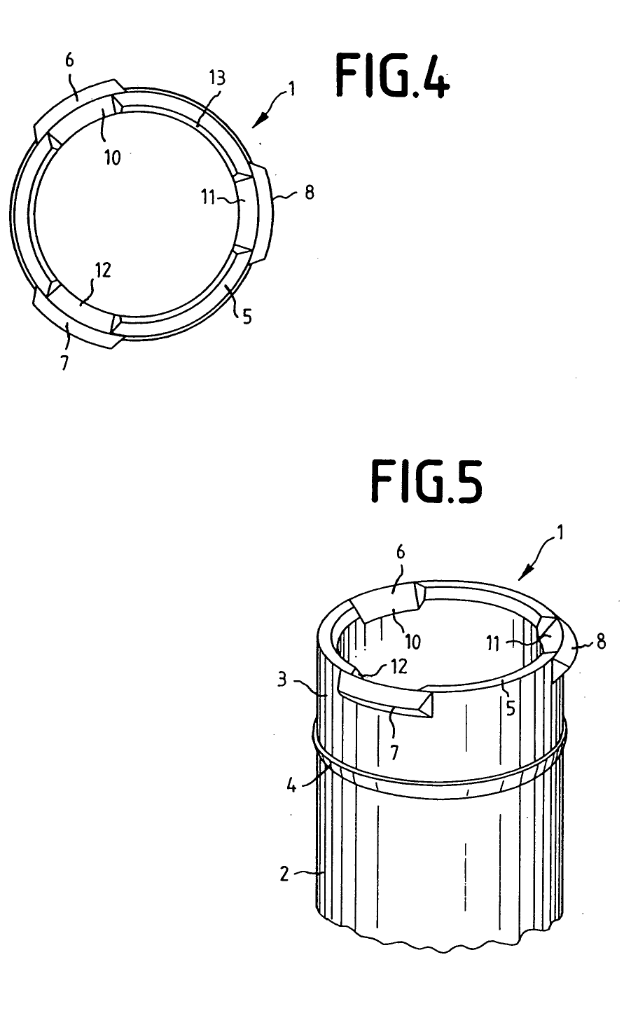

FIG. 3 a perspective representation of the first hose end,

FIG. 4 top view onto the edge region of a second hose end,

FIG. 5 a perspective representation of the second hose end,

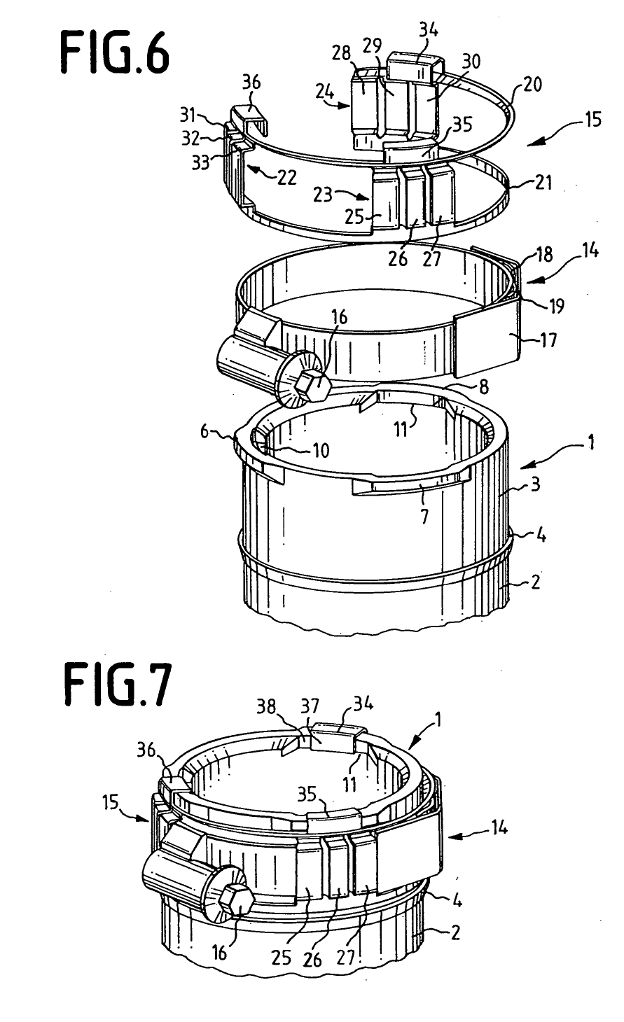

FIG. 6 an exploded representation comprised of hose end, band clamp fitting and clamp fitting securement,

FIG. 7 a band clamp fitting secured on the hose end,

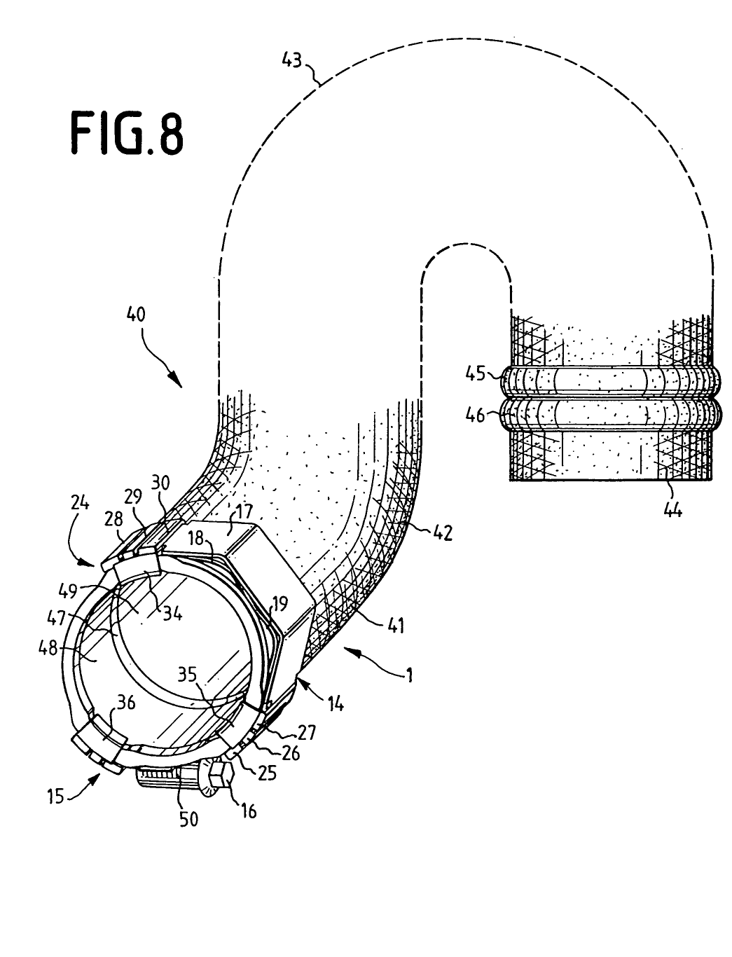

FIG. 8 a perspective representation of a hose utilized in a motor vehicle.

FIG. 1 shows a side view of a first embodiment of the hose end 1 according to the invention. This hose end 1 includes a lower cylindrical portion 2 and an upper cylindrical portion 3. Both portions 2, 3 are separated by a bulge 4. Onto the upper cylindrical portion 3 a (not shown) band clamp fitting can be drawn. Closely beneath the upper edge 5 of the hose end 1 are located three outwardly directed projections, of which only two projections 6, 7 are evident in FIG. 1.

FIG. 2 shows a view onto the upper edge of hose end 1. Herein the two projections 6, 7 as well as the third projection 8 can be seen. Relative to the inner wall 9 of hose end 1, these projections 6 to 8, are minimally offset toward the outside such that at the location of projections 6 to 8 one niche each 10 to 12 is formed. These niches 10 to 12 serve for receiving holding clips for the (not shown) band clamp fitting.

FIG. 3 shows the hose end 1 in perspective view. Again, two of the niches 10, 11 can be seen. Additionally, it is evident that from the inner wall 9 of hose end 1 a bevel 13 extends toward edge 5.

FIG. 4 depicts a view from above onto the edge 5 of a further hose end 14 according to the invention. It can be seen that the rear walls of niches. 10, 11, are strongly sloped, in contrast to the embodiment example of FIG. 1 to 3.

In FIG. 5 the hose end 1 is once again shown in perspective view. It can be seen that the top sides of projections 6 to 8 are sloped outwardly, stated differently, these top sides do not extend in the same plane as the edge 5.

FIG. 6 depicts an exploded representation, in which the hose end 1, a band clamp fitting 14 and a clamp fitting securement 15 are shown. The band clamp fitting 14 comprises a bolt 16 with (not shown) threads, these threads having the capability of mating with, also not shown, transverse knurls. The band clamp fitting 14, in addition, is provided with a large bow 17, which spans two small bows 18, 19. The clamp fitting securement is essentially comprised of two open rings 20, 21, which are connected by means of bridges 22, 23, 24, these bridges being formed in each instance by three webs 25 to 27; 28 to 30; 31 to 33, one disposed next to the other. In addition, flanged onto these bridges are clips 34 to 36 having a U-shaped cross section.

In FIG. 7 the structural parts, shown individually in FIG. 6, are connected with one another. The band clamp fitting 14 is fitted through the clamp fitting securement 15. The clamp fitting securement 15, in turn, is fixedly connected with the hose end 1 by means of clips 34 to 36. With their inwardly directed shank 37 the clips 34 to 36 are in contact on an inner wall 38 of the particular niche 10, 11. Since the clips 34 to 36 do not project into the space later filled by an exhaust manifold, they are not loosened during the mounting, which ensures the tight seating of hose band clamp fitting 14 and clamp fitting securement 15.

FIG. 8 shows once again a complete hose 40 such as can be applied in a motor vehicle. The hose 40 is here curved, with a first region 41 extending in a straight line into the plane of drawing, subsequently extending upwardly in a first curvature 42 and lastly in a second curvature 43 extending perpendicularly downwardly, where the second hose end 44 is located which is provided with bulges 45, 46.

The band clamp fitting 14 and the clamp fitting securement 15 are fastened on the first hose end 1. On the inside of hose end 1 is evident a depression 47, which is the complement of bulge 4. The inner diameter of the front region 48 of hose end 1 is greater than the inner diameter of the rear region 49 of hose end 1.

During the mounting the preassembled hose end 1 is slid onto an exhaust manifold and the bolt 16 is tightened, whose threads 50 mate with the ribbed outside of band clamp fitting 14, whereupon the latter compresses this hose end.

1. Hose with hose end having an edge, characterized in that immediately beneath the edge (5) and extending from the edge on the inside of the hose end at least one recess (10 to 12) is provided.

2. Hose as claimed in claim 1, characterized in that at a specified distance from the edge (5) on the outside of the hose end (1) an annular bulge (4) extends around the outer circumference of the hose end (1).

3. Hose as claimed in claim 1, characterized in that at a specified distance from the edge (5) on the inside of the hose end (1) an annular groove (47) extends around the inner circumference of the hose end (1).

4. Hose as claimed in claim 3, characterized in that the region (48) in front of the groove (47) has a greater inner diameter than the region (49) behind the groove.

5. Hose as claimed in claim 2, characterized in that the distance between the edge (5) and the bulge (4) corresponds at least to the width of a clamp fitting securement (15).

6. Clamp fitting securement for the application in a hose as claimed in claim 1, characterized in that it comprises at least one clip (34 to 36), which extends into a recess (10 to 12) on the inside of the hose end (1).

7. Clamp fitting securement as claimed in claim 6, characterized in that the clip (34) is implemented in the form of a U or an L, one shank (37) of this clip (34) disposed in contact on a wall (38) of the recess (11).

8. Clamp fitting securement as claimed in claim 6, characterized in that it comprises two parallel and open rings (20, 21) connected with one another via at least one bridge (22 to 24).

9. Clamp fitting securement as claimed in claim 6, characterized in that three equidistantly disposed clips (34 to 36) are provided.

10. Clamp fitting securement as claimed in claim 8, characterized in that the open rings (20, 21) are connected with one another via three bridges (22 to 24).

11. Clamp fitting securement as claimed in claim 8 or claim 10, characterized in that each bridge (22 to 24) is comprised of three webs (25 to 27; 31 to 33; 28 to 30).
